(19) United States
(12) Patent Application Publication
(10) Pub. No.: US 2025/0362078 A1
(43) Pub. Date: Nov. 27, 2025

(54) METHOD FOR DRYING AN INNER VOLUME OF A PRESSURE VESSEL AND DRYING SYSTEM

(71) Applicant: AuE Kassel GmbH, Kassel (DE)

(72) Inventors: David Viereck, Kassel (DE); Dennis Sommer, Kassel (DE); Rene Wanning, Kassel (DE); Jörn Battermann, Kassel (DE); Detlef Brüning, Essen (DE)

(21) Appl. No.: 19/096,824

(22) Filed: Apr. 1, 2025

(30) Foreign Application Priority Data
Apr. 5, 2024 (DE) 10 2024 109 588.1

(51) Int. Cl. F26B 3/04; F26B 9/06; F26B 21/00; F26B 25/00

(52) U.S. Cl. CPC F26B 3/04; F26B 9/06; F26B 21/001; F26B 25/003

(57) ABSTRACT

A method for drying an inner volume of a pressure vessel and to a drying system. The method includes at least the following method steps:
flowing through the inner volume with a gaseous first fluid at a flow rate of at least 250 l/min and a temperature of at least 70° C., and
flowing through the inner volume with a second gaseous fluid at a flow rate of at least 250 l/min, having a humidity value of less than 100 ppm and a temperature of at least 70° C.

### CROSS REFERENCE TO RELATED APPLICATIONS

This application claims the benefit of priority under 35 U.S.C. § 119 to German Patent Application No.: 10 2024 109 558.1, filed Apr. 5, 2024, the contents of which is incorporated herein by reference in its entirety.

### FIELD

The invention relates to a method for drying an inner volume of a pressure vessel and to a drying system for pressure vessels, comprising a support frame for receiving and retaining at least one pressure vessel. The drying system has at least one movable lance which can be inserted at least partially into the pressure vessel.

### BACKGROUND

The statements in this section merely provide background information related to the present disclosure and several definitions for terms used in the present disclosure and may not constitute prior art.

In the state of the art, pressure vessels are used for a variety of applications. Such pressure vessels are often made from carbon fiber. Carbon fiber pressure vessel winding is a process in which carbon fibers are wrapped around a core or mold to produce lightweight but still very strong vessels. The carbon fiber strands are typically pulled through a resin and then wrapped around a rotating mold under tension. The mold determines the final shape of the vessel. The resin hardens and binds the fibers together, resulting in a compact, resistant mesh. After winding, such pressure vessels are usually subjected to a pressure test using water as a test medium. The inner volume of the pressure vessels must therefore be dried before further processing.

Drying the inner volume of pressure vessels mainly uses the techniques of heat supply, vacuum application or a combination of both. In the heat supply method, the inside of the vessel is heated by blowing in hot gases, which accelerates the evaporation of moisture. Alternatively, infrared heaters can be used to achieve uniform heating. Vacuum drying, on the other hand, subjects the inside of the vessel to vacuum to reduce the boiling point of the water and thus enable more efficient moisture removal at lower temperatures. These techniques are often combined to increase drying efficiency.

Furthermore, pressure vessels may have an inner layer—liner—, for example made of a thermoplastic resin. It is not possible to dry these vessels using a vacuum, as this would destroy the inner layer.

Conventional methods also have the disadvantage that they have very long process runtimes and automation of the drying process is only possible with great effort. An objective of the present disclosure is therefore based on providing a method for drying the inner volume of a pressure vessel and a drying system which are suitable for pressure vessels with an inner layer, which ensure a short process time and which enable the drying process to be automated as far as possible.

### SUMMARY

The aforementioned objective is solved with a method for drying an inner volume of a pressure vessel, which comprises at least the following method steps:
flowing through the inner volume with a gaseous first fluid at a flow rate of at least 250 l/min, preferably with a humidity value in the range of 16,000 ppm (water) to 22,000 ppm (water), in particular before heating, and at a temperature of at least 70° C., preferably at least 90° C., advantageously for a period of between 25 minutes and 75 minutes, and
flowing through the inner volume with a second gaseous fluid at a flow rate of at least 250 l/min, with a humidity value of less than 100 ppm (water) and a temperature of at least 70° C., preferably at least 90° C., in particular for a period of between 15 minutes and 45 minutes.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a schematic sequence of according to one embodiment of a method according to the present disclosure;

FIG. 2 shows a perspective view of a drying system with a pressure vessel in place according to the present disclosure;

FIG. 3 shows a section of the drying system without a pressure vessel;

FIG. 4 shows a section of the drying system with a pressure vessel;

FIG. 5 shows a further section of the drying system without a pressure vessel; and

FIG. 6 shows another section of the drying system without pressure vessel.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, a method for drying an inner volume of a pressure vessel is provided. This method may comprise at least the following method steps:
flowing through the inner volume with a gaseous first fluid at a flow rate of at least 250 l/min, preferably with a humidity value in the range of 16,000 ppm (water) to 22,000 ppm (water), in particular before heating, and at a temperature of at least 70° C., preferably at least 90° C., advantageously for a period of between 25 minutes and 75 minutes, and
flowing through the inner volume with a second gaseous fluid at a flow rate of at least 250 l/min, with a humidity value of less than 100 ppm (water) and a temperature of at least 70° C., preferably at least 90° C., in particular for a period of between 15 minutes and 45 minutes.

During the execution of the method, i.e. during the drying operation, the pressure vessel is preferably retained in a support frame of a drying system. Preferably, at least five pressure vessels are simultaneously retained in the support frame of a drying system, in which the method is carried out simultaneously but independently of one another.

Preferably, at first, the flowing through with the first gaseous fluid takes place and then the flowing through with the second gaseous fluid. Particularly preferred, the first fluid is ambient air, which is drawn in in the vicinity of the drying system and heated. In particular, the pressure of the first fluid corresponds to the ambient pressure, i.e. in particular approximately 1,013 mbar. The humidity value of the first fluid is, for example, in the range of 16,000 ppm to 22,000 ppm (water), in particular before or after the heating, and is therefore, for example, in the range of normal indoor air. Ambient air is understood to be air that is present at a workplace where people can carry out work, for example in a factory workshop. In particular, the exact parameters are of secondary importance. The humidity value of the first fluid is preferably calculated from a measured value of the relative humidity, e.g. with a hygrometer, and the temperature before heating. The second fluid is in particular dried air, preferably ambient air, which has also been heated. The pressure of the second fluid corresponds in particular to the ambient pressure, i.e. in particular approximately 1,013 mbar.

The ambient air, and thus in particular the first fluid and/or the second fluid, has, for example, approximately the following composition (excluding water, in volume-%): 78% nitrogen, 20.94% oxygen, 0.93% argon, and 0.04% carbon dioxide. It is advantageously provided that the first gaseous fluid and/or the second gaseous fluid is nitrogen, helium, oxygen and/or a mixture thereof.

The preferred flow rates for the first fluid and/or the second fluid are in the range between approximately 250 l/min and 600 l/min, preferably between approximately 350 l/min and 550 l/min, particularly preferably between 400 l/min and 550 l/min. For example, the flow rate of the first fluid and/or the second fluid is at least or about 350 l/min or at least or about 400 l/min or at least or about 450 l/min or at least or about 500 l/min. Preferably, the upper limit for the first fluid and/or the second fluid is about 600 l/min or about 550 l/min.

The flowing through preferably takes place in such a way that the first fluid or the second fluid flows into the inner volume of the pressure vessel through an opening and flows out again from an opening. In particular, the flowing through comprises an inflow of the first or second fluid into the inner volume and an outflow. It is provided that the inflow and outflow take place through a single opening or that the inflow and outflow take place through different openings. Preferably, the cross-section for the inflow and outflow is approximately the same. For example, it is also provided that a dwell time and/or a flow velocity of the first fluid and/or the second fluid in the inner volume is controlled via the cross-sections for the inflow and outflow. For example, a cross-section for inflow is smaller, the same or larger than a cross-section for outflow. It is particularly preferably provided that the cross-section for outflow is larger than the cross-section for inflow, in particular in order not to increase the pressure in the pressure vessel during drying.

Surprisingly, it has been found that very good drying results can be achieved with the method according to the present disclosure in a considerably shorter process time compared to conventional methods if the pressure vessel is successively flowed through for different periods of time with two gaseous fluids, preferably the same or different, having different properties. This also results in energy savings compared to conventional methods.

According one embodiment of the present disclosure, it has been found to be particularly advantageous if it is provided that the first fluid has a temperature of between 100° C. and 130° C. when flowing through, in particular when flowing in. A temperature of approximately 110° C. or 120° C. is particularly preferred. With regard to the second fluid, it has also been found to be advantageous if it is provided that the second fluid has a temperature of between 90° C. and 130° C. when flowing through, in particular when flowing in, preferably a temperature of about 110° C. or about 120° C. is also provided. Particularly advantageous drying results can be achieved at these temperatures. These temperatures with the above-mentioned flow rates are suitable for both large vessels and small vessels, so that approximately identical drying results can be achieved. The upper limit for the temperature of the first fluid and/or the second fluid is preferably about 200° C.

According another embodiment, particularly advantageous drying results can be achieved in that the flowing through with the first fluid takes place for a period of between 40 minutes and 50 minutes. A period of about 45 minutes is particularly preferred. Preferably, the flowing through with the second fluid takes place for a period of between 25 minutes and 35 minutes.

Particularly preferably, it is provided that the flowing through with the first fluid takes place for a period of 4 to 18 seconds, in particular 6 seconds to 16 seconds, per liter of the volume of the pressure vessel and/or that the flowing through with the second fluid takes place for a period of 2 seconds to 12 seconds, in particular 4 seconds to 10 seconds, per liter of the volume of the pressure vessel.

The drying performance can be increased in particular in that it is provided that the second fluid has a moisture value of equal to or less than 80 ppm (water), in particular a moisture value of equal to or less than 50 ppm (water), preferably equal to or less than 10 ppm (water), particularly preferably between 1 ppm and 5 ppm (water) when flowing into the pressure vessel. These advantageous moisture values ensure optimum drying results for the inner volume when flowing through with the second fluid.

To control the drying process, it is preferably provided that a moisture value of the second fluid flowing out of the pressure vessel is measured. Preferably, the second fluid flows out of an opening of the pressure vessel into a recess on a support frame on the drying system, which has at least one lateral branch channel. A pump is connected to the branch channel, which sucks in a part of the outflowing fluid and feeds it to the moisture measurement. The moisture measurement is preferably carried out with a sensor that works with phosphorus pentoxide technology based on the electrolytic dissociation of water, for example the AQUATRACE® ATT520V Transmitter 0-500 ppmV sensor of the company DKS GmbH. Preferably, it is provided that the moisture value of the second fluid flowing out of the pressure vessel is measured continuously, in particular starting with the flowing through with the second fluid, but is only evaluated after a predetermined period of time has elapsed or is used to control the drying process. Preferably, it is provided that the measurement values are used for the control when the measurement values reach the measuring range of the sensor, for example falling below 500 ppm water.

Particularly preferably, it is provided that the flowing through with the second fluid is continued, in particular after the preferred time period has elapsed, until a moisture value of the second fluid flowing out of the pressure vessel is less than 80 ppm, in particular less than 50 ppm, preferably less than 20 ppm.

Alternatively or additionally, it is provided that the flowing through with the first fluid and/or with the second fluid, in particular with the second fluid, is repeated if, in particular after expiry of the aforementioned, preferred time durations, or after a predetermined time duration after completion of the flowing through with the second fluid, e.g. between 20 seconds and 60 seconds, a moisture value of 20 ppm in the outflowing second fluid is not undercut. Preferably, it is provided that the flowing through with the first fluid and/or the second fluid takes place at most twice.

According to one embodiment of the method, it is provided that the flowing through takes place through a single opening of the pressure vessel, namely that an inflow and an outflow of the first fluid and the second fluid take place through the same opening of the pressure vessel. Preferably, the pressure vessel only has a single opening through which the inflow and outflow take place. For example, the flowing through takes place using at least one lance that is inserted through the opening into the inner volume while the method is being carried out. Preferably, the inflow takes place through the interior of the lance and the outflow through a surrounding space, e.g. annular space, which is formed between the opening and the lance. In particular, it may also be provided that the inflow takes place through the surrounding space and the outflow takes place through the interior of the lance.

For carrying out the method, the lance is preferably inserted so deeply into the pressure vessel that an inflow of the first fluid and the second fluid takes place approximately in the second end region of the pressure vessel, opposite the opening, such that the fluids flow through the entire length of the pressure vessel in order to exit the pressure vessel again at the opening at the first end region.

According to one embodiment, it is particularly preferably provided that the lance is made of a fiber composite material, in particular carbon fiber. This makes the lance particularly resistant.

For the method running smoothly, it has proven to be advantageous if it is provided according to an embodiment that a drying of the second fluid takes place prior to the flowing through in a cold-regenerating adsorption dryer and/or a heating of the first and/or second fluid takes place by means of an electric heating element. This allows a stable process flow to be provided that can be easily automated.

A further embodiment of the method provides in particular that the second fluid is dried, e.g. by ambient air, before flowing through a cold-regenerating adsorption dryer. Furthermore, it is advantageously provided that the first fluid and/or the second fluid is heated using at least one electrical heating element, preferably a plurality of heating elements.

According to another embodiment of the method, it is also provided that the pressure vessel is oriented essentially vertically during the flowing through, in particular that an opening of the pressure vessel used for the inflow and outflow is oriented in the vertical direction essentially upwards. This allows the fluids enriched with moisture to escape upwards in an advantageous manner.

A further embodiment of the method provides that after the flowing through with the second fluid and after a removal of the lance out of the inner volume, at least one opening, in particular all openings, of the pressure vessel are closed. For example, a plug or a lid is used for closing. Closing serves to prevent moisture from entering the inner volume.

Alternatively, the method may be formulated to dry an inner volume of a pressure vessel, comprising at least the following method steps:
flowing through the inner volume with a gaseous first fluid at a flow rate of at least 250 l/min, with a moisture value in the range from 16,000 ppm to 22,000 ppm, in particular before the heating, and at a temperature of at least 70° C., and
flowing through the inner volume with a second gaseous fluid at a flow rate of at least 250 l/min, with a moisture value of less than 100 ppm and at a temperature of at least 70° C.

The respective embodiments of this method result from the exemplary embodiment described above and below and their features.

The present disclosure also relates to a drying system for pressure vessels, which has at least one support frame for at least partially receiving and retaining at least one pressure vessel, preferably at least five pressure vessels. In addition, at least one movable lance is provided for each pressure vessel. The lance can be inserted, in particular automated, into the inner volume of a pressure vessel. The drying system is advantageously configured and set up for carrying out a method according to one of the described embodiments.

When automating the method for drying the inner volume of a pressure vessel, the insertion of the lance is a critical method step, since the lance must be inserted centrally into a relatively small opening of the pressure vessel without damaging the lance or the pressure vessel. As a solution, the present disclosure also relates to a drying system for pressure vessels, which has a support frame for receiving and retaining at least one pressure vessel. For each pressure vessel, at least one movable lance is provided for insertion into a pressure vessel. In addition, at least two holding arms are provided for each pressure vessel, which can be moved towards each other in translation. The holding arms have such a shape that a connecting piece of a pressure vessel, which usually surrounds the opening of the pressure vessel, is centered between the holding arms in a predetermined position when the holding arms are moved towards each other. The drying system is advantageously configured and set up for carrying out a method according to one of the described embodiments.

The holding arms are preferably held, in particular directly or indirectly, on the support frame in such a way that they can be moved in a vertical direction and, in particular along an imaginary axis X, can be moved towards each other. For retaining a pressure vessel, the holding arms are preferably moved towards each other by way of a linear movement and the connection piece and thus the opening of the pressure vessel between the two holding arms is always centered at the same location. The movable lance can then be easily inserted through the opening into the inner volume of the pressure vessel.

According to another embodiment, it is preferable that each holding arm has at least one first holding area and at least one second holding area, and that the first holding area and the second holding area are arranged relative to one another in such a way that a connecting piece on each holding arm can be centered between the first holding area and the second holding area. For example, an angle of less than 180° is formed between the first holding area and the second holding area. By means of this angle, a connecting piece of the pressure vessel is automatically centered on each holding arm between the first holding area and the second holding area. For example, it is provided that the first and second holding area of a holding arm, in particular the holding areas of all holding arms, are arranged in an imaginary plane, preferably also movable.

In order to position the two holding arms at the correct height in relation to a longitudinal extension of the pressure vessel, the drying system has at least one stop surface for a connection piece of the pressure vessel. For example, both holding arms together with the stop surface are movably held, in particular automatically, for example on a slide. The stop surface is preferably resiliently mounted and has at least one sensor with which a movement of the stop surface can be detected, for example by contact with an end face of a connection piece. The stop surface can advantageously be moved towards a pressure vessel until the stop surface rests against the end face of the connection piece. As soon as contact between the stop surface and the end face of the connection piece is detected, the movement is stopped and the holding arms are automatically positioned correctly in the longitudinal direction in relation to the connection piece. Stopping the movement is preferably controlled on the basis of signals from the sensor.

The holding arms can then be moved towards each other until the connection piece is always centered between the holding arms at the same point. Finally, the lance is retracted and a drying method is started, in particular as described above.

This way of centering of the pressure vessel has the advantage that even pressure vessels that have a curvature in relation to their longitudinal direction are positioned correctly. These are always displaced into the correct position by means of the attachment only to the connection piece.

Further advantageous embodiments of the present disclosure are shown in the following description of figures.

In the various figures of the drawing, identical parts are always marked with the same reference signs.

With regard to the following description, it is claimed that the present disclosure is not limited to the exemplary embodiments and thereby not to all or several features of described feature combinations, rather each individual partial feature of the/each embodiment is also of importance for the subject matter of the invention independently of all other partial features described in connection therewith, and also in combination with any features of another exemplary embodiment.

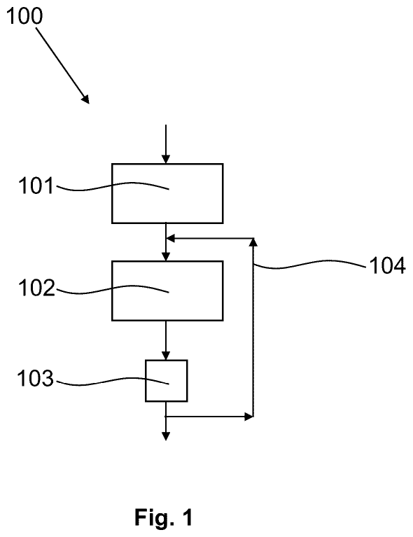

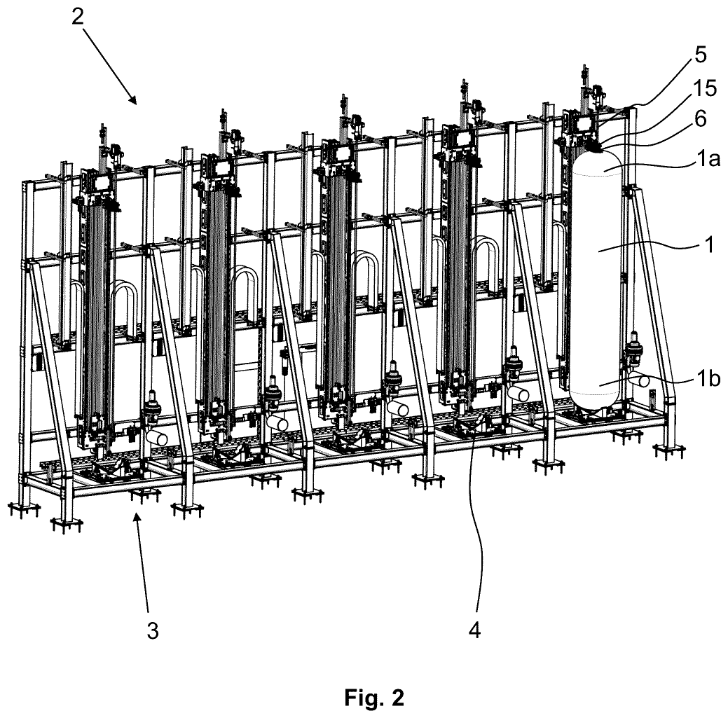

FIG. 1 shows an exemplary embodiment of a method 100 for drying an inner volume of a pressure vessel 1 shown by way of example in FIG. 2. The pressure vessel 1 is intended, for example, for receiving hydrogen and is made of wound carbon fiber. According to FIG. 1, the exemplary embodiment of the method 100 comprises at least the flowing through 101 of the inner volume of the pressure vessel 1 with a gaseous first fluid. The first fluid is passed through the inner volume of the pressure vessel 1 at a flow rate of at least 250 l/min, in particular with a moisture value in the range from 16,000 ppm to 22,000 ppm (water), preferably before heating, and at a temperature of at least 70° C. Preferably, the flowing through takes place for a period of between 25 minutes and 75 minutes.

Then, the flowing through 102 of the inner volume of the pressure vessel 1 with a second gaseous fluid takes place with a flow rate of at least 250 l/min, with a humidity value of less than 100 ppm and a temperature of at least 70° C. The flowing through with the second fluid is preferably carried out for a period of between 15 minutes and 45 minutes.

The first fluid is preferably ambient air that has been heated with an electric heating element—not shown. The second fluid is preferably dried air, in particular ambient air, which has been dried with a cold-regenerating adsorption dryer—also not shown. Particularly preferably, the flowing through 101 with the first fluid takes place at a temperature in the range between 100° C. and 130° C. The first fluid preferably flows through the inner volume for a period of between 40 minutes and 50 minutes.

It is particularly preferred if the second fluid has a moisture value of less than 80 ppm (water), in particular less than 50 ppm (water), preferably less than 10 ppm (water), in particular in the range from 1 ppm to 10 ppm (water), when it flows into the pressure vessel 1. Advantageously, measuring 103 of the moisture value of the second fluid flowing out of the pressure vessel 1 takes place, whereby the evaluation or use of the measured value for the control only begins after a predetermined period of time.

If, for example, after the second flowing through 102, a moisture value in the outflowing second fluid does not fall below 80 ppm (water), in particular 50 ppm (water), preferably 20 ppm (water), the flowing through 102 with the second fluid is preferably repeated 104. Thereby, it is provided that the flowing through 102 is repeated at most once. If the aforementioned moisture value in the outflowing second fluid is then not undercut, the pressure vessel 1 is considered to be a reject and is discharged automatically, for example.

FIG. 2 shows an exemplary embodiment, in particular of a part of a drying system 2 for pressure vessels 1. The drying system 2 has five receiving spaces 3 for receiving pressure vessels 1. Each receiving space 3 has a bearing block 4 with three inclined surfaces inclined towards each other, in each of which a vessel end 1b, in particular a curved one, can be centered. Each receiving space 3 has a lance 5 that can be moved in a direction parallel to a longitudinal axis of a pressure vessel 1 for insertion into an opening 6 of a pressure vessel 1. In the method according to FIG. 1, the one opening 6 is used for the inflow and outflow of the first fluid and the second fluid. The inflow takes place through the lance 5, the outflow through the surrounding space 15 surrounding the lance 5, here annular, of the opening 6. In this exemplary embodiment, the lances 5 are made of carbon fiber. The hose lines leading to the lances 5 are preferably coated with polyether ether ketone to ensure diffusion tightness. FIG. 2 shows that the pressure vessels 1 can be accommodated in the drying system 2 essentially vertically with the opening 6 facing upwards.

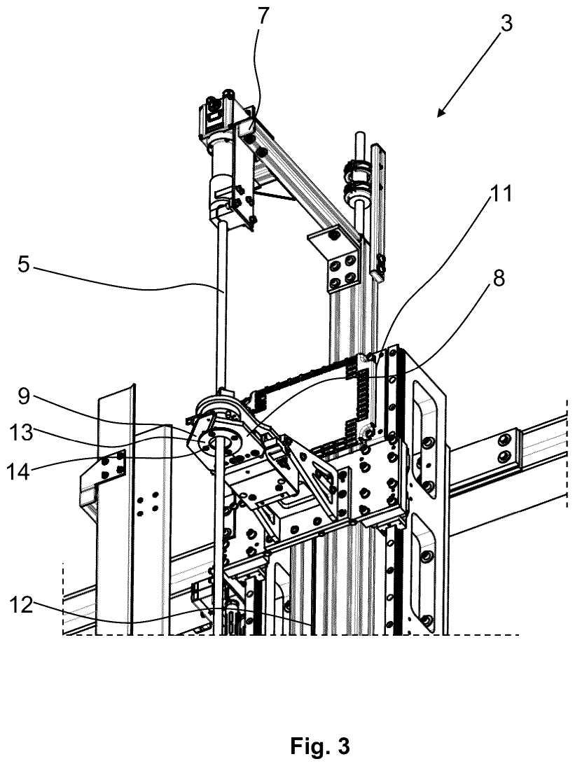

FIGS. 3 to 6 show detailed views of a receiving space 3 of a drying system 2 according to FIG. 2 with and without pressure vessel 1 or with lance 5 in a retracted position (FIGS. 3, 4, 5 and 6). The lance 5 is held on a lance suspension 7, which can be moved separately along the longitudinal direction of the lance 5, so that the lance 5 can be moved into and out of an opening 6 of a pressure vessel 1 in an automated manner.

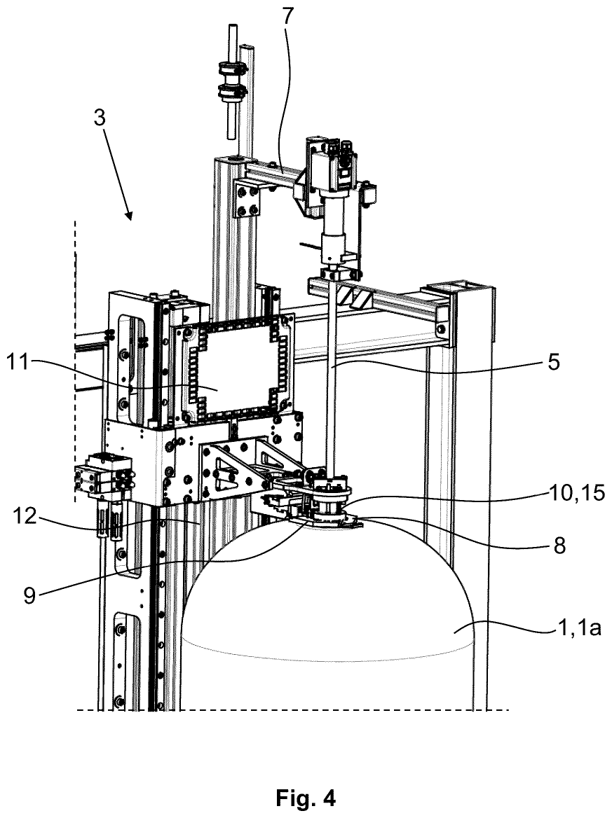

In order to position a pressure vessel 1—as shown in FIG. 4—below the lance 5, each receiving space 3 of the drying system 2 has at least one first holding arm 8 and at least one second holding arm 9, with which a connecting piece 10, which surrounds the opening 6 of the pressure vessel 1, can be centered at a predetermined position when the holding arms 8, 9 are moved towards each other.

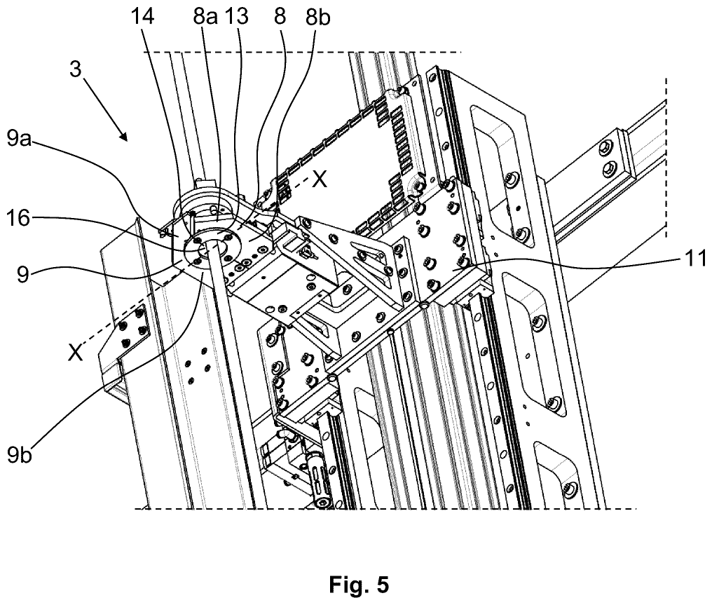

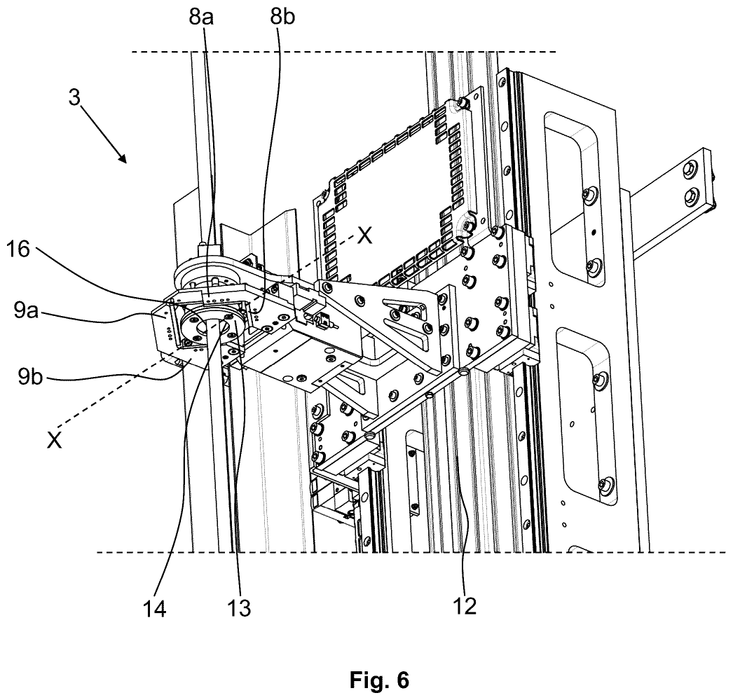

According to FIG. 3 to FIG. 6, the holding arms 8, 9 are held on a support frame 11, which can be moved along a rail 12 essentially parallel to a longitudinal axis of the pressure vessel 1, in particular in an automated manner. The holding arms 8, 9 are held on the support frame 11 in such a way that they can be moved towards and away from each other in a direction orthogonal to the direction of displacement along the rail 12 in order to center a connection piece 10 of a pressure vessel 1. FIG. 5 shows the holding arms 8, 9 in a closed position, in which a pressure vessel 1 is centered as shown in FIG. 4. FIG. 6 shows an opened position of the holding arms 8, 9 before they are moved towards each other.

Each holding arm 8, 9 has a first holding area 8a, 9a and a second holding area 8b, 9b according to FIGS. 5 and 6. In this exemplary embodiment, the first holding areas 8a, 9a are each arranged at an angle of approximately 90° to the second holding areas 8b, 9b in a common, imaginary plane. If the holding arms 8, 9 are now moved towards each other along the axis X, a connecting piece 10 of a pressure vessel 1 is centered at a predetermined position between the first holding area 8a, 9a and the second holding area 8b, 9b (see FIG. 4).

In order to position the holding arms 8, 9 correctly in relation to the connection piece 10 of a pressure vessel 1 with respect to the longitudinal axis of the pressure vessel 1, the support frame 11 has an annular stop surface 13 which can be moved together with the holding arms 8, 9 along the longitudinal axis of a pressure vessel 1. The stop surface 13 is preferably spring-mounted, whereby a movement of the stop surface 13 against the spring force can be detected by a sensor—not shown—in order to stop a movement of the support frame 11 on the slide 12.

If the support frame 11 is moved towards a pressure vessel 1, the movement continues until the resiliently mounted stop surface 13 rests against the end face of a connection piece 10 of the pressure vessel 1. The movement of the support frame 11 along the longitudinal axis of the pressure vessel 1 along the rail 12 is then stopped and the holding arms 8, 9 can be moved towards each other to center the connection piece 10 or the pressure vessel 1.

By using holding arms 8, 9 that can be moved towards each other along an axis X, the pressure vessel 1 is centered with its opening 6 at a predetermined position, regardless of its actual shape, so that the lance 5 can then be inserted into the pressure vessel 1 (see, for example, FIG. 4). The lance 5 passes through the annular stop surface 13 in a recess 14. The fluids flowing out of the pressure vessel 1 also emerge from the inner volume through the recess 14 and are directed into the environment, for example. Preferably, a moisture sensor—not shown—is arranged in this recess 14 or adjacent to this recess 14, with which the moisture value of the second fluid emerging from the pressure vessel 1 is determined. For example, the moisture sensor is arranged in a branch channel 16 (see FIG. 6), which branches off from the recess 14, in particular orthogonally, and which is connected to a pump in order to draw a fluid into the branch channel 16 and thus to the moisture sensor.

To carry out the method 100, the lance 5 is preferably inserted so deeply into the pressure vessel 1 that the first fluid and the second fluid flow in approximately in the second end region 1b of the pressure vessel 1, opposite the opening 6, so that the fluids flow through the entire length of the pressure vessel 1 in order to exit the pressure vessel 1 again at the opening 6 at the first end region 1a.

The invention is not limited to the illustrated and described embodiments, but also includes all embodiments having the same effect in the sense of the invention. It is expressly emphasized that the embodiments are not limited to all features in combination, rather, each individual part feature can also have an inventive significance in its own independently of all other part features. Furthermore, the invention is not yet limited to the combination of features defined in any embodiment, but can also be defined by any other combination of certain features of all the individual features disclosed. This means that, in principle, practically any individual feature of any embodiment can be omitted or replaced by at least one individual feature disclosed elsewhere in the application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A method for drying an inner volume of a pressure vessel, comprising at least the following method steps:
flowing through the inner volume with a gaseous first fluid at a flow rate of at least 250 l/min and having a temperature of at least 70° C.,
flowing through the inner volume with a second gaseous fluid at a flow rate of at least 250 l/min, having a moisture value of less than 100 ppm and a temperature of at least 70° C.

2. The method according to claim 1, wherein the flowing through with the first fluid takes place for a period of between 25 min and 75 minutes or, for a period of between 40 min and 50 minutes.

3. The method according to claim 1, wherein the first fluid is ambient air and the second fluid is dried air, or dried ambient air.

4. The method according to claim 1, wherein at least one of the first fluid has a temperature of between 100° C. and 130° C. when flowing through or wherein the first fluid has a temperature of between 100° C. and 130° C. when flowing in.

5. The method according to claim 1, wherein the second fluid has a moisture value of equal to or less than 80 ppm, or a moisture value of equal to or less than 50 ppm, or equal to or less than 10 ppm, or between 1 ppm and 5 ppm, when flowing into the pressure vessel.

6. The method according to claim 1, wherein the moisture value of the second fluid flowing out of the pressure vessel is measured.

7. The method according to claim 1, wherein the flowing through with the second fluid is continued until the moisture value in the second fluid flowing out of the pressure vessel is less than 80 ppm, or less than 50 ppm, or less than 20 ppm.

8. The method according to claim 1, wherein the flowing through with at least one of the first fluid or the second fluid, is repeated.

9. The method according to claim 1, wherein the flowing through with at least one of the first fluid or the second fluid takes place through a single opening of the pressure vessel.

10. The method according to claim 1, wherein the flowing through with at least one of the first fluid or the second fluid takes place by means of a lance which is introduced into the inner volume of the pressure vessel (1).

11. The method according to claim 1, wherein at least one of a drying of the second fluid takes place before the flowing through in a cold-regenerating adsorption dryer or a heating of the first fluid takes place with an electric heating element.

12. The method according to claim 1, wherein the pressure vessel is oriented substantially vertically during the flowing through.

13. A drying system for pressure vessels, comprising a support frame for receiving and retaining at least one pressure vessel comprising at least one movable lance for insertion into a pressure vessel, wherein the drying system is configured and set up for carrying out a method comprising at least the following method steps:
flowing through the inner volume with a gaseous first fluid at a flow rate of at least 250 l/min and having a temperature of at least 70° C. and
flowing through the inner volume with a second gaseous fluid at a flow rate of at least 250 l/min. having a moisture value of less than 100 ppm and a temperature of at least 70° C.

14. A drying system for pressure vessels, comprising a support frame for receiving and retaining at least one pressure vessel, comprising at least one movable lance for insertion into the pressure vessel, wherein at least two holding arms are present, wherein the holding arms can be moved towards one another, and wherein the holding arms have such a shape that a connection piece of a pressure vessel is centered between the holding arms at a predetermined position when the holding arms are moved towards one another.

15. The drying system according to claim 14, wherein each holding arm has at least one first holding region and at least one second holding region, and wherein the first holding region and the second holding region are arranged such that a connecting piece is centered on each holding arm between the first holding region and the second holding region.

16. The method according to claim 1, wherein the flowing through with the second fluid takes place for a period of between 15 minutes and 45 minutes or for a period of between 25 minutes and 35 minutes.

17. The method according to claim 1, wherein at least one of the second fluid has a temperature of between 90° C. and 130° C. when flowing through or wherein the second fluid has a temperature of between 90° C. and 130° C. when flowing in.

18. The method according to claim 6, wherein an evaluation of the moisture value only begins after a predetermined period of time.

19. The method according to claim 1, wherein the flowing through with at least one of the first fluid or the second fluid is repeated if after a predetermined period of time, a moisture value of 20 ppm in the outflowing second fluid is not underrun.

20. The method according to claim 10, wherein an inflow takes place through the inner volume of the lance and that an outflow takes place around the lance.
